(19) United States
(12) Patent Application Publication
(10) Pub. No.: US 2014/0086663 A1
(43) Pub. Date: Mar. 27, 2014

(54) ASSEMBLY MADE OF A FLAT WRITING INSTRUMENT AND OF AN ELEMENT THAT HOLDS THE WRITING INSTRUMENT INSIDE AN EXERCISE BOOK OR NOTEBOOK

(71) Applicants: Philippe Peyridieu, Milano (IT); Henry Sanderson, Breda (NL)

(72) Inventors: Philippe Peyridieu, Milano (IT); Henry Sanderson, Breda (NL)

(21) Appl. No.: 14/115,476

(22) PCT Filed: May 2, 2012
(86) PCT No.: PCT/FR2012/050975

§ 371 Date: Nov. 4, 2013

(30) Foreign Application Priority Data
May 2, 2011 (FR) 1153744

(51) Int. Cl. B43K 23/00

(52) U.S. Cl. CPC B43K 23/001
USPC 401/131

(57) ABSTRACT

An assembly is made of a flat writing instrument (1) and of an element (2) for holding the writing instrument (1) against a supporting surface of an exercise book or notebook, for immobilizing the instrument (1) in a storage position in which it extends parallel to the supporting surface. The element (2) is made of a body (21) having a first fixing face (211) which is intended to be applied to the supporting surface, and a second face (221) opposite to the fixing face (211) and carrying elements for immobilizing the instrument (1), the fixing face (211) carrying elements for fixing the holding element (2) to the supporting surface such that the element (2) can be fixed to the supporting surface without protruding from the exercise book or notebook.

The present invention relates to the field of writing instruments and particularly to means enabling to hold a writing instrument on a flat surface, namely the inner cover of an exercise book or notebook.

“Writing instrument” means any instrument having a writing or marking or drawing tip, for example pens, pencils, felt-tip markers, felt pens or similar.

It is common to fix a pen to the support on which one writes by means of a pinching element being in the form of an elongated lip fixed to one end of the pen or to the cap thereof and which loosely and removably presses the edge of the support.

An exemplary system based on a pinching fixing is disclosed in the international patent application WO2004085171 which relates to an assembly made of a flat pen-type writing instrument and of a clamping device comprising two elastic legs for being arranged against a page of an exercise book or notebook, a leg on each side of the page, and for pinching it to hold the clamping device in position on said page.

Another exemplary similar system is disclosed in the British patent application GB 2 290 264, this system being made of a flat pen-type writing instrument and of an elongated elastic body, an end region of which is formed by a curved elastic part and the other end region of which is formed by a U-return.

The curved elastic part is intended to be engaged with a recess arranged at the end of the writing instrument and carries a button and a notch, the button extending inside an opening provided in the body of the writing instrument when the latter is fixed to the elastic body and the notch holding the writing instrument in the fixing position.

The elastic body is fixed to a page of an exercise book by pinching said page in the inner space formed by the U-return, namely between both inner faces of the U-return, which inner faces are facing each other: a first face which carries the button and the notch and is applied to the surface of said page which is at the side of the page where the writing instrument extends, and a second face which is applied to the opposite surface of said page, namely the one being on the other side of said page.

In other words, the elastic body comprises a U-return forming two inner faces facing each other and between which is pinched the edge of the page on which the writing instrument-elastic body system is fixed.

In each case, the writing instrument is fixed to the edge of a page, either directly if it carries a pinching lip, or indirectly as in the case of the above-described clamping device or elastic body, and an inopportune separation of the writing instrument and/or the clamping device with respect to the exercise book or notebook is still possible during handling or transport of the exercise book or notebook in a bag.

Furthermore, the pinching action required for fixing the writing instrument to the exercise book or notebook can damage the edge of the page to which the writing instrument is fixed.

Thus, the present invention aims to provide an assembly made of a flat writing instrument and of an element for holding the writing instrument which can prevent an inopportune separation of the writing instrument without damaging pages of the exercise book or notebook.

Thus, the present invention relates to an assembly made of a flat writing instrument and of a holding element that holds the writing instrument against a flat supporting surface of an exercise book or notebook, consisting for instance in a surface of a cover or page of the exercise book or notebook, which holding element is intended to be placed against the supporting surface and to removably immobilize the writing instrument in a storage position wherein it extends parallel to the supporting surface, characterized in that the holding element is formed of a body having a first flat face, so-called fixing face, which is intended to be applied to the supporting surface, and a second face opposite the fixing face and carrying means for immobilizing the writing instrument in the storage position, the fixing face carrying means for fixing the holding element to the supporting surface.

Thus, the holding element, via the fixing means, is capable of being fixed to the supporting surface without protruding from the exercise book or notebook, compared to known clamping or pinching devices which do not comprise two opposite faces, as in the present invention, but comprise two faces facing each other which are applied to the support, on either side thereof, protruding from the exercise book or notebook, without being fixed to the supporting surface.

In other words, in the present invention, both opposite faces are separated by the body while, in the prior art, both faces facing each other are separated by a gap for receiving the edge of a cover or page of the exercise book or notebook, so as to pinch it between the faces facing each other.

The fact that the holding element does not protrude from the exercise book or notebook allows to prevent the inadvertent separation thereof, for example when the exercise book or notebook rubs against a surface such as the inner surface of a bag in which the exercise book or notebook is stored.

The flatness of the writing instrument and of the holding element allows not altering the outer appearance of the exercise book or notebook when it has been closed on the assembly according to the invention.

The writing instrument can be advantageously chosen such that the length thereof is lower than the maximum size of the exercise book or notebook, particularly lower than the length or width thereof, such that the holding element can be fixed to the supporting surface of the exercise book or notebook in a position such that the holding element-writing instrument assembly does not protrudes from the exercise book or notebook when the writing instrument is in the storage position. In this way, there is no risk that the writing instrument is inadvertently separated from the holding element, because nothing is protruding from the exercise book or notebook.

In addition, when the writing instrument has a size allowing it to be entirely in the exercise book or notebook in its storage position, it is not required to provide a closing cap protecting the writing tip. Of course, the writing instrument can however be provided with such a cap.

Preferably, the means for fixing the holding element is a fixing adhesive means, optionally removable. “Removable adhesive” means an adhesive allowing, if need be, to stick or unstick the holding element. The user can thus unstick the holding element to fix it on another supporting surface.

The fixing adhesive means of the holding element can consist in a double-sided adhesive tape applied to the fixing face of the holding element, the adhesive being present on the free face of the double-sided adhesive tape once it has been fixed to the fixing face being, if applicable, a removable adhesive.

The adhesive present on the face of the adhesive tape which is applied to the holding element can also be a removable adhesive.

The means for fixing the holding element to the supporting surface can also be formed by one or more clips intended to be hooked to the supporting surface.

The body of the holding element can be in the form of a tablet having a first flat surface constituting said fixing face and a second surface constituting said second face carrying the means for immobilizing the writing instrument, which immobilizing means being formed by loops, or hooks, arranged on said second surface of the tablet, the writing instrument carrying hooks, or loops, for engaging with the loops, or hooks, of the holding element for immobilizing the writing instrument to the holding element by loops and hooks.

Alternatively, the body of the holding element can be in the form of a tablet having a first flat surface constituting said fixing face and a second surface constituting said second face carrying the means for immobilizing the writing instrument, which immobilizing means being formed by a member consisting in a magnet, or a material capable of being attracted by a magnet, the writing instrument carrying a member consisting in a material capable of being attracted by a magnet, or a magnet, for immobilizing the writing instrument to the holding element under the magnetic attraction force therebetween.

Also alternatively, the means for immobilizing the writing instrument to the holding element can be formed by a metal element arranged for engaging under pressure with a metal element carried by the writing instrument, for immobilizing the writing instrument to the holding element in a snap-fastener manner.

Preferably, the body of the holding element is in the form of a flat block having a flat surface constituting said fixing face, block in which is provided a cavity which opens on one side of the body with an orientation substantially parallel to said fixing face and is sized for receiving a portion of the writing instrument and holding it in the storage position thereof, said cavity being delimited by a lower surface constituting said second face of the body and by an upper wall having an upper surface which is facing said lower surface, one of the lower surface, or the upper surface, of the cavity and the portion of the writing instrument which is inserted in said cavity when the writing instrument is in the storage position, carrying a protrusion for being received in a recess provided in the other of the lower surface, or the upper surface, of the cavity and the portion of the writing instrument which is inserted in said cavity when the writing instrument is in its storage position, said protrusion and recess being sized so as to provide a stop by abutment in the insertion/removal direction of the writing instrument with respect to the holding element, once the writing instrument has been arranged in its storage position.

In other words, the protrusion can be provided in the cavity and the recess on the writing instrument, or vice versa.

This mechanism for fixing the writing instrument to the holding element enables to securely immobilize the writing instrument while allowing an easy insertion and removal thereof.

Preferably, the writing instrument comprises a flat elongated body having one end from which a writing tip extends and a second opposite end from which a flat fastener extends, thickness of which is equal or lower than the height of the cavity, defined as the maximum distance between the lower surface and the upper surface of the cavity, for allowing the fastener to be received in the cavity of the holding element when the writing instrument is in its storage position, position in which a first surface of the fastener is facing the lower surface of the cavity and a second surface opposite to the first surface is facing the upper surface of the cavity, the first surface or the second surface of the fastener carrying said recess or protrusion, whether the protrusion or the recess is carried, respectively, by the lower surface or the upper surface of the cavity.

The second end of the body of the writing instrument can have a shape complementary to the first side of the body of the holding element, on which opens the cavity, distances between, on one hand, the recess, or the protrusion, of the fastener and the second end of the body of the writing instrument and, on the other hand, the protrusion, or the recess, and the first side of the body of the holding element being equal such that, in the storage position of the writing instrument, the second end of the body of the writing instrument fits the first side of the body of the holding element.

An opening can be provided in the upper wall of the cavity, at a second side of the body opposite to the first side of the body, on which opens the cavity, the length of the fastener being larger than the distance between said first side of the body and said opening such that the fastener is accessible through said opening when the writing instrument is in its storage position.

Preferably, the protrusion of the holding element is carried by the upper surface of the cavity, the thickness of the fastener is lower than the height of the cavity and the fastener is carried by the body of the writing instrument such that, in the storage position thereof, the second surface of the fastener is in contact with the upper surface of the cavity and a clearance is formed between the first surface of the fastener and the lower surface of the cavity.

In this way, the protrusion of the holding element can be disengaged from the recess of the fastener by simply sliding the writing instrument in the removal direction. It can be noted that placing the writing instrument in its storage position and removing it from the holding element can be performed with one gesture using only one hand, which is particularly convenient for the user who can thus, for example, hold the exercise book or notebook with the other hand.

It can here be noted that said clearance can be small, provided that it is larger than the height on which said recess and said protrusion abut against each other, so as to allow the fastener to be lowered.

Preferably, the external surface of the upper wall of the cavity and the external surface of the body of the writing instrument, which is intended to face in the opposite direction of the supporting surface in the storage position of the writing instrument, have the same cross-sectional shape, and the height of the body of the holding element, defined as the maximum distance between the fixing face and the external surface of the upper wall of the cavity in the direction perpendicular to the fixing face, is substantially equal to the thickness of the portion of the writing instrument which is not inserted in the cavity in the storage position of the writing instrument.

Thus, the assembly made of the writing instrument and of the holding element has, in the storage position, a continuous outer surface which does not damage the page which is applied against it when the exercise book or notebook is closed.

Preferably, the flat body of the writing instrument and the flat body of the holding element have a cross-section having a speed bump shape, the flat external surface of which is intended to face the supporting surface on which the holding element is fixed.

Such a speed bump configuration allows the pages of the exercise book or notebook to adapt to the external contour of the holding element and the pen, once the exercise book or notebook is closed, thereby minimizing the risk of permanent deformation or deterioration of said pages.

The thickness of the body of the writing instrument and the height of the flat body of the holding element can be equal to 4 mm, so as not to deform too much the exercise book or notebook when closed.

In order to better illustrate the present invention, a particular embodiment is described below, with reference to appended drawings.

On these drawings:

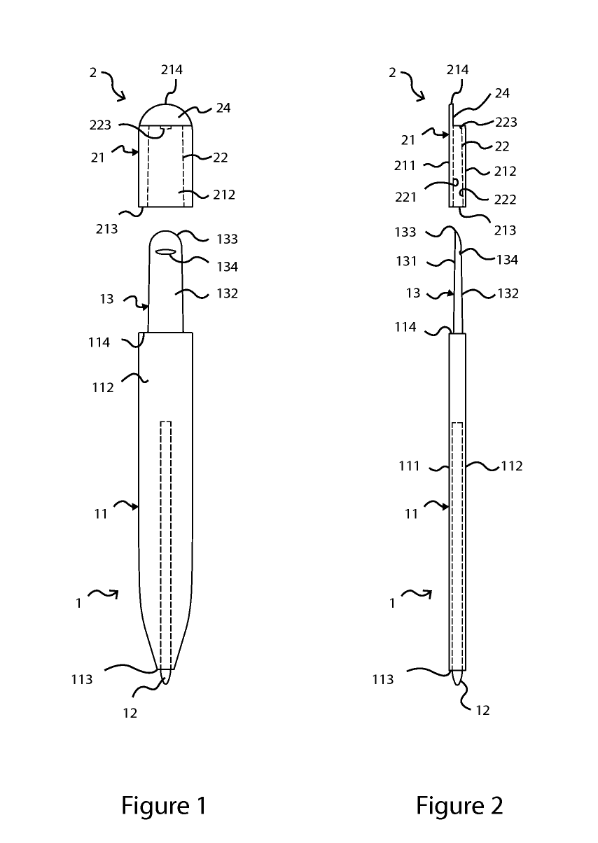

FIGS. 1 and 2 show respectively top and side exploded views of the assembly made of a writing instrument and a holding element according to the present invention;

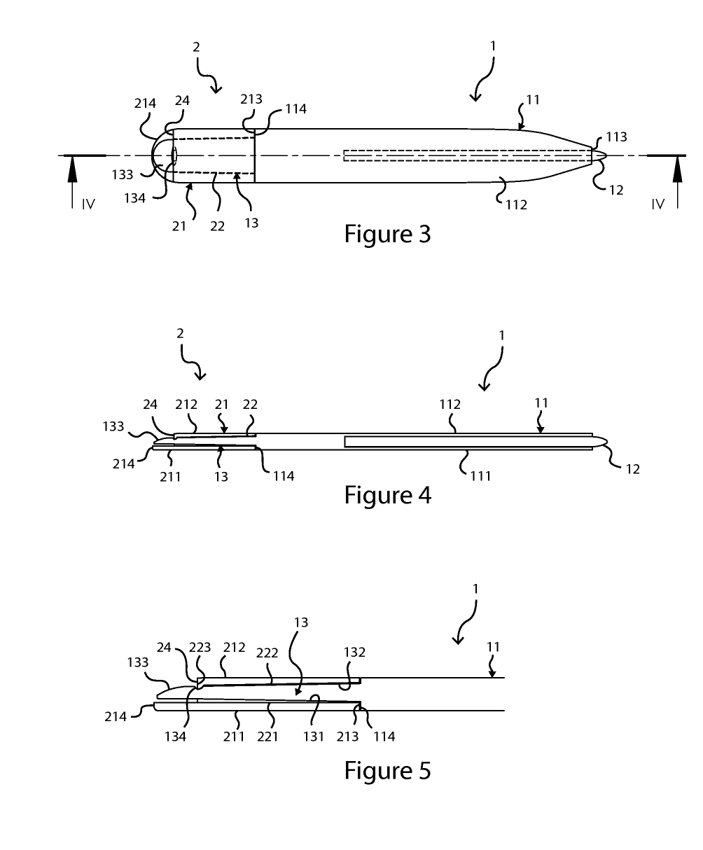

FIG. 3 shows a top view of the assembly according to the present invention, in the storage position of the writing instrument;

FIG. 4 shows a longitudinal cross-sectional view of the holding element of the assembly according to the present invention, with the writing instrument in its storage position;

FIG. 5 shows an enlarged view of the holding element in the storage position of the writing instrument represented on FIG. 4;

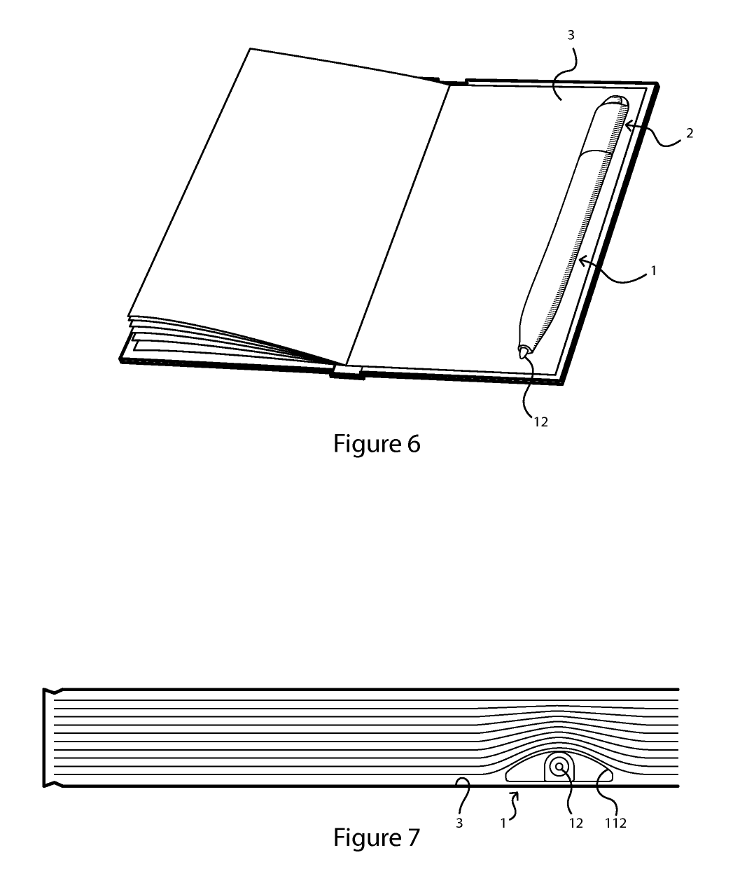

FIG. 6 shows a top perspective view of an opened notebook, on the inner face of the cover of which is fixed the holding element according to the present invention, the writing instrument being in its storage position; and

FIG. 7 shows an end view of the assembly according to the present invention, on the writing tip side of the writing instrument, the notebook represented on FIG. 6 having been closed on the assembly according to the present invention.

With reference to FIGS. 1 and 2, the assembly according to the present invention is made of a flat pen-type writing instrument 1 and of a holding element 2 arranged for engaging with each other.

The pen 1 comprises a flat elongated body 11 having a speed bump-shaped cross-section. Thus, the body 11 has a flat external lower surface 111 and an arched external upper surface 112.

A writing tip 12 extends from one end 113 of the body 11, which writing tip 12 is supplied with ink by a cartridge arranged inside the body 11, in the region of the end 113.

A fastener 13, integrally formed with the body 11, extends from the end 114 of the body 11, which is flat and opposite to the end 113.

The fastener 13 is in the form of a flat tab protruding from the body 11 in the average longitudinal direction of the body 11 and in a direction opposite to the tip 12. The flat tab has also a cross-section in the shape of a speed bump, with a flat lower surface 131 and an arched upper surface 132, the free end 133 of the tab being rounded.

The thickness of the fastener 13, defined as the maximum distance between both surfaces 131 and 132 in the direction perpendicular to the flat lower surface 131, is lower than that of the body 11, which is also the maximum distance between both surfaces 111 and 112, and the tab is carried by the body 11 such that the flat lower surface 131 is not in the extension of the external lower surface 111 of the body 11, but is offset with respect to it.

A recess 134 is provided in the arched upper surface 132, in a position closer to the free end 133 than the end 114 of the body 11.

The holding element 2 is formed by a body 21 having the shape of an elongated and integral block.

The body 11 of the pen 1 and the body 21 of the holding element 2 are made of plastic material.

The cross-section of the body 21 has the shape of a speed bump, with a flat lower surface 211 and an arched upper surface 212.

A double-sided adhesive tape, not shown, is applied to the flat lower surface 211.

The body 21 has an outer shape and outer dimensions chosen to match at least those of the region of the end 114 of the pen.

The body 21 is provided with a cavity 22 which is elongated in the average longitudinal direction of the body 21 and which opens on a first side 213 of the body 21. The first side 213 is flat.

The cavity 22 has also a speed bump-shaped cross-section and is thus delimited by a flat lower surface 221 and an arched internal upper surface 222.

The body 21 is also provided with an opening 24 provided in the arched upper surface 212 of the body 21, on a second side 214 of the body 21 opposite to the first side 213. The second side 214 is rounded and the curve thereof is similar to that of the free end 133 of the fastener 13.

The cavity 22 is sized such that the fastener 13 can be inserted therein and, once it has been inserted therein, the free end 133 thereof extends in the opening 24, as shown in FIG. 3.

In reference to FIGS. 4 and 5, a protrusion 223 extends from the inner upper surface 222, at the free edge thereof opposite to the first side 213, to the interior of the cavity 22.

The distance between the protrusion 223 and the first side 213 of the body 21, in the longitudinal direction of the body 21, is equal to the distance between the recess 134 and the end 114 of the body 11 in the longitudinal direction of the body 11.

Dimensions of the protrusion 223 and the recess 134 are chosen to allow the protrusion 223 to come in the cavity 134 and to prevent any movement of the pen 1. For example, the protrusion 223 and the recess 134 have a depth of respectively 0.5 mm and 0.6 mm, a length of respectively 2 mm and 2.1 mm and a width of respectively 3 mm and 5 mm.

The distance between the lower surface 131 of the fastener 13 and the external lower surface 111 of the body 11, in the direction perpendicular to the lower surface 131, is at least slightly higher than the distance between the lower surface 211 of the holding element 2 and the lower surface 221 of the cavity 22.

The thickness of the body 11, defined as the maximum distance between the external lower surface 111 and the arched external upper surface 112, is substantially equal to the height of the body 21 of the holding element 2, defined as the maximum distance between the lower surface 211 and the arched upper surface 212. The bodies 11 and 21 having a speed bump-shaped cross-section, these maximum distances are obtained at the average longitudinal line thereof.

Finally, the distance between the arched upper surface 132 of the fastener 13 and the arched upper surface 112 of the body 11, in the direction perpendicular to the upper surface 132, is equal to the thickness of the upper wall of the cavity, that is, the distance between the internal upper surface 222 of the cavity 22 and the arched upper surface 212 of the holding element 2.

These specific dimensions of the pen 1 and the holding element 2 allow them to extend in the extension of each other when the pen 1 has been placed in the holding element 2, so as to form an assembly having a smooth external contour with no risk to damage the pages of the exercise book or notebook in which it is fixed, the pen 1 being in contact with or in close proximity to the surface on which the holding element 2 is fixed.

When the user desires to store the pen 1, he just has to insert the fastener 13 in the cavity 22 with only one gesture, the protrusion 223 slightly abutting against the free end 133 of the fastener 13 for slightly lowering it, the fastener 13 raising when the recess 134 is facing the protrusion 223, position in which the protrusion 223 is accommodated in the cavity 134 and prevents any movement of the pen 1.

In this storage position of the pen 1, it is removably and securely fixed to the holding element 2.

In addition, due to the fact that the body 21 has, as indicated above, an outer shape and outer dimensions matching those of the region of the end 114 of the body 11, that this end 114 perfectly fits the first side 213 of the body 21 and that the end 133 lies in the same curve as the second side 214 of the body 21, the assembly made of the pen 1 and the holding element 2 has an homogeneous shape, without protruding or sharp parts which could tear or pierce the surface on which the assembly is fixed.

When the user desires to get back the pen 1 fixed to the holding element 2, he just has to slide the body 11 of the pen 1 in the direction opposite to the holding element 2 so as to remove the fastener 13 from the holding element 2. Indeed, applying a pressure for sliding the pen 1 is enough to disengage the protrusion 223 from the recess 134, because such disengagement requires a low effort.

It can be noted that the holding element 2 and the fastener 13, as above-described, enable to easily and quickly fix and release the pen 1, because they require only one gesture using one hand of the user.

In reference to FIG. 5, the holding element 2 can be permanently fixed to a supporting surface 3, formed by the interior of a cover or page of an exercise book or notebook, by means of the double-sided adhesive tape.

Thus, the holding element 2 can be fixed in a position and orientation such that the pen 1 does not protrude from the exercise book or notebook when it is held in the holding element 2.

The assembly made of the writing instrument and the holding element according to the present invention can thus prevent any inadvertently separation of the pen 1 and/or holding element 2.

In reference to FIG. 6, when the exercise book or notebook has been closed on the pen 1 and the holding element 2, the speed bump shape thereof causes the pages lying above them to slightly curve to follow their external contour, thereby minimizing the risk of permanent deformation or deterioration of the pages.

Of course, the embodiment which was described above was given by way of example but not as a limitation and modifications can be made without departing from the scope of the present invention.

1-12. (canceled)

13. Assembly made of a flat writing instrument and of a holding element that holds the writing instrument against a flat supporting surface of an exercise book or notebook, consisting for instance in a surface of a cover or page of the exercise book or notebook, which holding element is intended to be placed against the supporting surface and to removably immobilize the writing instrument in a storage position wherein it extends parallel to the supporting surface, characterized in that the holding element is formed of a body having a first flat face, so-called fixing face, which is intended to be applied to the supporting surface, and a second face opposite the fixing face and carrying means for immobilizing the writing instrument in the storage position, the fixing face carrying means for fixing the holding element to the supporting surface.

14. The assembly according to claim 13, characterized in that the means for fixing the holding element is a fixing adhesive means, optionally a removable fixing adhesive means.

15. The assembly according to claim 14, characterized in that the fixing adhesive means of the holding element consists in a double-sided adhesive tape applied to the fixing face of the holding element.

16. The assembly according to claim 13, characterized in that the body of the holding element is in the form of a tablet having a first flat surface constituting said fixing face and a second surface constituting said second face carrying the means for immobilizing the writing instrument, which immobilizing means being formed by loops, or hooks, arranged on said second surface of the tablet, the writing instrument carrying hooks, or loops, for engaging the loops, or the hooks, of the holding element for immobilizing the writing instrument to the holding element by loops and hooks.

17. The assembly according to claim 13, characterized in that the body of the holding element is in the form of a tablet having a first flat surface constituting said fixing face and a second surface constituting said second face carrying the means for immobilizing the writing instrument, which immobilizing means being formed by a member consisting in a magnet, or a material capable of being attracted by a magnet, the writing instrument carrying a member consisting in a material capable of being attracted by a magnet, or a magnet, for immobilizing the writing instrument to the holding element under the magnetic attraction force there between.

18. The assembly according to claim 13, characterized in that the means for immobilizing the writing instrument to the holding element is formed by a metal element arranged for engaging under pressure with a metal element carried by the writing instrument, for immobilizing the writing instrument to the holding element in a snap-fastener manner.

19. The assembly according to claim 13, characterized in that the body of the holding element is in the form of a flat block having a flat surface constituting said fixing face, block in which is provided a cavity which opens on one side of the body with an orientation substantially parallel to said fixing face and is sized for receiving a portion of the writing instrument and holding it in the storage position thereof, said cavity being delimited by a lower surface constituting said second face of the body and by an upper wall having an upper surface which is facing said lower surface, one of the lower surface, or the upper surface, of the cavity and the portion of the writing instrument which is inserted in said cavity when the writing instrument is in its storage position, carrying a protrusion for being received in a recess provided in the other of the lower surface, or the upper surface, of the cavity and the portion of the writing instrument which is inserted in said cavity when the writing instrument is in its storage position, said protrusion and recess being sized so as to provide a stop by abutment in the insertion/removal direction of the writing instrument with respect to the holding element, once the writing instrument has been arranged in its storage position.

20. The assembly according to claim 19, characterized in that the writing instrument comprises a flat elongated body having one end from which a writing tip extends and a second opposite end from which a flat fastener extends, thickness of which is equal or lower than the height of the cavity, defined as the maximum distance between the lower surface and the upper surface of the cavity, for allowing the fastener to be received in the cavity of the holding element when the writing instrument is in its storage position, position in which a first surface of the fastener is facing the lower surface of the cavity and a second surface opposite to the first surface is facing the upper surface of the cavity, the first surface or the second surface of the fastener carrying said recess or protrusion, whether the protrusion or the recess is carried, respectively, by the lower surface or the upper surface of the cavity.

21. The assembly according to claim 20, characterized in that the second end of the body of the writing instrument has a shape complementary to the first side of the body of the holding element, on which opens the cavity, distances between, on one hand, the recess, or the protrusion, of the fastener and the second end of the body of the writing instrument and, on the other hand, the protrusion, or the recess, and the first side of the body of the holding element being equal such that, in the storage position of the writing instrument, the second end of the body of the writing instrument fits the first side of the body of the holding element.

22. The assembly according to claim 20, characterized in that the protrusion of the holding element is carried by the upper surface of the cavity, the thickness of the fastener is lower than the height of the cavity and the fastener is carried by the body of the writing instrument such that, in the storage position thereof, the second surface of the fastener is in contact with the upper surface of the cavity and a clearance is formed between the first surface of the fastener and the lower surface of the cavity.

23. The assembly according to claim 19, characterized in that the external surface of the upper wall of the cavity and the external surface of the body of the writing instrument, which is intended to face in the opposite direction of the supporting surface in the storage position of the writing instrument, have the same cross-sectional shape, and in that the height of the body of the holding element, defined as the maximum distance between the fixing face and the external surface of the upper wall of the cavity in the direction perpendicular to the fixing face, is substantially equal to the thickness of the portion of the writing instrument which is not inserted in the cavity in the storage position of the writing instrument.

24. The assembly according to claim 19, characterized in that the flat body of the writing instrument and the flat body of the holding element have a cross-section having a speed bump shape, the flat external surface of which is intended to face the supporting surface on which the holding element is fixed.

25. Assembly made of a flat writing instrument and of a holding element that holds the writing instrument against a supporting surface of an exercise book or notebook, which holding element is intended to be placed against the supporting surface and to removably immobilize the instrument in a storage position wherein it extends parallel to the supporting surface, characterized in that the holding element is formed of a body having a first flat face, so-called fixing face, which is intended to be applied to the supporting surface, the body further comprising a connection mechanism for immobilizing the instrument in the storage position, the fixing face carrying means for fixing the holding element to the supporting surface.

26. Assembly made of a flat writing instrument and of a holding element configured to hold said flat writing instrument against a flat supporting surface, said holding element comprising a body having a first flat face having means for fixing said holding element to the flat supporting surface such that said assembly is removably secured to the flat supporting surface solely by contact between said fixing means and the flat supporting surface, said body further comprising a connection mechanism configured to secure the flat writing instrument to the holding element.
